(19) United States
(12) Patent Application Publication
(10) Pub. No.: US 2004/0162926 A1
(43) Pub. Date: Aug. 19, 2004

(54) Serial advanced technology attachment interface

(76) Inventor: Itzhak Levy, Hollywood, FL (US)

Correspondence Address: LERNER AND GREENBERG, PA, P O BOX 2480, HOLLYWOOD, FL, 33022-2480, US

(21) Appl. No.: 10/666,222

(22) Filed: Sep. 18, 2003

Related U.S. Application Data
(60) Provisional application No. 60/447,811, filed on Feb. 14, 2003.

(51) Int. Cl. G06F 12/00

(52) U.S. Cl. 710/74; 711/112; 711/114

(57) ABSTRACT

The present invention relates to an intermediate hard disk drive adapter for a computer system and, in particular, to an inexpensive high performance, high reliability intermediate hard disk drive adapter for a computer system utilizing the Serial ATA method of communicating between the central processor and the hard disk drives.

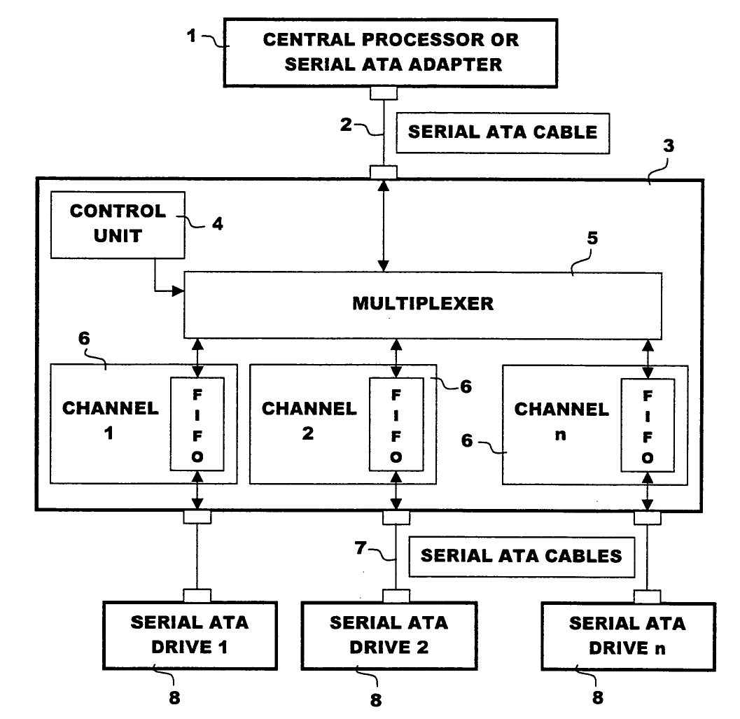

### CROSS-REFERENCE TO RELATED APPLICATION

This application claims the benefit under 35 U.S.C. § 119(e) of copending provisional application No. 60/447,811 filed Feb. 14, 2003.

### BACKGROUND OF THE INVENTION

1. Field of the Invention

The invention lies in the computer technology field. More specifically, the invention relates to an intermediate hard disk drive adapter for a computer system and, in particular, to a disk drive adapter utilizing the Serial ATA (Advanced Technology Attachment) standard for communication between the central processor and the hard disk drive system.

The term “computer system” as used herein should be understood in a very wide sense of the term. That is, the device and system described herein will be functional with any device that transfers data using Serial ATA. While the most common use of the invention will likely be with desktop computers or servers, the device according to the invention works with a multitude of other specialized devices such as point-of-sale terminals, computer numerical controllers, medical testing and monitoring equipment, and many other similar systems and devices. The invention should be understood to broadly apply to all such systems and devices.

2. Description of the Related Art

The most common method of long term storage of programs and data on present day computer systems is the hard disk drive. A hard disk drive is an electromechanical device consisting of one or more rotating platters or disks, a movable electromagnetic transducer, and electronics to convey the information between the central processor and the disks. The hard disk drive is typically connected to the central processor using two cables. One cable supplies power to the hard disk drive. The power cable is of no concern to the present invention. The other cable carries the electrical signals that convey the information to be stored to or retrieved from the hard disk drive.

As computer systems have evolved, a number of different methods of connecting the hard disk drive to the central processor, or interfaces, have been developed. These interfaces are distinguished by the particular type of cable that is used to connect between the hard disk drive and the central processor. Presently the most common interfaces are Small Computer Systems Interface (SCSI) and Integrated Drive Electronics/Enhanced Integrated Drive Electronics (IDE/EIDE). Other standards are under development and, as will follow from the description below, the present invention provides for one of the standards.

The hard disk drive, while designed to be very reliable, is prone to failure because of the high speed mechanical operations that it is required to perform. Since failure of the hard disk drive may destroy all the programs and data that it contains, recovery to normal operation is difficult or impossible if the programs and data cannot be restored from another source. For this reason, a number of different means to copy or “back up” hard disk programs and data have been developed.

Programs and data can be transferred (backed up) to another medium such as floppy disks, magnetic tape, or CDROMS. This, however, is slow and requires the dedication of the central processor for the duration of the transfer. Programs and data can be transferred over a computer network and stored on a second computer. This has several disadvantages, namely:

multiple computers are required, as well as a computer network to interconnect them;

significant resources are required from the central processor; and

special software (programs) to accomplish the transfer.

Additionally, there are a number of different schemes to back up programs and data on multiple hard disk drives. This invention addresses one of these schemes.

The process of storing and retrieving programs and data on multiple hard disk drives is known as RAID. The acronym RAID stands for “Redundant Array of Independent Disks” or “Redundant Array of Inexpensive Disks”. There are a number of different ways to store data on multiple hard disk drives. A more detailed discussion of RAID systems is found in a book entitled, The RAID Book: A Source Book for RAID Technology, published Jun. 9, 1993, by the RAID Advisory Board, Lino Lakes Minn.

The present invention primarily addresses the version of RAID variously known as “RAID level 1”, “RAID 1” or “mirroring”, although other versions of RAID or combinations of RAID and disk storage are possible. In RAID 1, programs or data to be stored on a hard disk drive are simultaneously stored on two hard drives. Programs or data to be retrieved from a hard disk drive are retrieved from either of the two hard drives. If one hard disk drive should fail, all programs and data can be retrieved from the other drive and copied onto a replacement hard disk drive, thus preserving the security of the programs and data. This can be performed while the host processor continues to operate normally.

RAID operation may be accomplished either by dedicated programs (software) on the central processor, a combination of hardware (electronics) and software, or dedicated hardware. The first two implementations are slow, cumbersome to maintain and operate, and substantially error prone.

Software implementations require dedicated programs which use computer resources while operating and must be adapted to computers running different operating systems. Hardware and software implementations do not connect directly in the data path between the computer and the hard disk. They generally connect via the computer's PCI Bus. This consumes hardware resources such as interrupts, memory space and input/output address space, and requires different device driver software for computers with different operating systems. Computer data must follow a longer and slower path through the PCI bus, then it must be converted to serial ATA compatible form before being delivered to the target drives.

The invention is a completely hardware implementation. The unique feature of the invention is that it is inserted between the Serial ATA connector of the host computer system and the Serial ATA connectors of the target hard drives. The computer and its operating system have no cognizance of the invention. Thus the invention is completely transparent to the type of computer or its operating system.

### SUMMARY OF THE INVENTION

It is accordingly an object of the invention to provide a serial ATA interface and a communications method which overcomes the above-mentioned disadvantages of the heretofore-known devices and methods of this general type and which provides for a system and hardware solution to the problem of optimal mirroring while achieving higher performance, higher data availability, and lower cost.

With the foregoing and other objects in view there is provided, in accordance with the invention, a computer system, comprising a processor generating data output, a hard disk drive adapter designed to function as an intermediate adapter connected to receive the data output from the processor and configured to send the data output to one or more channels, and a plurality of data storage devices each connected to the intermediate adapter via a respective serial ATA cable and each receiving the data output of a respective channel.

In accordance with an added feature of the invention, the processor is a central processor with a serial ATA adapter communicating with the intermediate adapter via a serial ATA cable.

In accordance with an additional feature of the invention, the processor generates the data in serial ATA standard and the intermediate adapter is configured to communicate in the serial ATA standard.

In accordance with another feature of the invention, the intermediate adapter is configured to implement substantially automatic, substantially instantaneous RAID 1 hard disk drive mirroring, or other disk data transfer, via serial ATA.

With the above and other objects in view there is also provided, in accordance with the invention, an intermediate adapter, comprising a serial ATA interface acting as an input for communicating with a central processor, and acting as an output for a plurality of serial ATA interfaces each for communicating with a respective serial ATA storage device, and means for mirroring, or splitting, a data input from the central processor to a plurality of channels each assigned to a respective one of the serial ATA interfaces for communicating with the serial ATA storage devices.

In other words, the present invention is a dedicated electronics version of a mirroring backup system. In its simplest form, it is configured to connect to one Serial ATA port from the central processor and to two or more Serial ATA hard disk drives.

The invention thus provides for an inexpensive, high performance, high reliability intermediate adapter for a computer system utilizing the Serial ATA method of communicating between the central processor and the hard disk drive system

The invention has several advantages. By way of example, inter alia, the invention

enables the implementation of substantially automatic, substantially instantaneous RAID 1 hard disk drive mirroring, or other disk data transfer, for Serial ATA at a lower cost than other systems;

helps prevent lost data and lost time when a hard disk drive failure occurs;

provides for a hard disk drive adapter designed to function as an intermediate adapter, connected to an existing Serial ATA connector, thereby eliminating the need to use other central processor resources such as expansion card slots, interrupts, input/output space, and address space; and

provides an intermediate adapter designed to function with any operating system presently available or future operating system which supports the Serial ATA interface, without requiring device drivers or any support by the operating system itself.

This invention pertains to a new interface known as Serial ATA (SATA). Hard disk drive manufacturers supply hard disks with particular interface types. Central processors provide a corresponding interface either on the main computer circuit board (motherboard) or through a dedicated circuit card that is plugged into one of the expansion slots on the motherboard.

The Serial ATA interface was developed to address several limitations imposed by previous interfaces. Serial ATA is capable of transferring data at higher speeds than other presently available interfaces. Cabling is smaller and can be longer, reducing clutter inside the computer and, at the same time, reducing electrical noise, allowing for more reliable data transfer.

In contrast with the prior art, where only one serial ATA hard disk drive may be connected to each connector on the central processor, the novel adapter allows immediate and concurrent mirroring to any number of such serial ATA drives.

Other features which are considered as characteristic for the invention are set forth in the appended claims.

Although the invention is illustrated and described herein as embodied in a serial ATA, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawing.

### BRIEF DESCRIPTION OF THE DRAWING

The FIGURE is a block diagram of a system incorporating the novel serial ATA interface.

### DESCRIPTION OF THE PREFERRED EMBODIMENTS

Referring now to the sole FIGURE of the drawing in detail, there is shown a block diagram illustrating, by way of example, a hard disk array system for a personal computer system or a small network server 1. A central processor communicates with a control unit via a serial ATA (advanced technology attachment) cable 2. The central processor has a serial ATA adapter for communication with the disk array.

The intermediate adapter 3 according to the invention has a control unit 4 which communicates with the central processor via an interface and the serial ATA cable 2. The control unit 4 accepts commands from the central processor 1 and generates several signals for division into a plurality of channels 6. The signals may be switched into the individual channels via a multiplexer 5. In the case where data are requested from the serial ATA drive, the control unit selects the drive to be read. The control unit also handles error reporting and recovery. Any number of channels may be provided, depending on the size of the disk array. Each channel 6 contains a First-In-First-Out (FIFO) memory device for buffering the data, in both directions, between the central processor 1 and the hard drives 8. Each channel communicates with a respective serial ATA drive 8, independently of each other or of the central processor, via a serial ATA cable 7.

I claim:

1. A computer system, comprising:
a processor generating data output;
a hard disk drive adapter forming an intermediate adapter connected to receive the data output from said processor and configured to distribute the data output to a plurality of channels; and
a plurality of data storage devices each connected to said hard disk drive adapter via a respective serial ATA cable and each receiving the data output of a respective channel.

2. The computer system according to claim 1, wherein said intermediate adapter is configured to mirror or split the data output to the plurality of channels.

3. The computer system according to claim 1, wherein said processor is a central processor with a serial ATA connector communicating with said intermediate adapter via a serial ATA cable.

4. The computer system according to claim 1, wherein said processor is configured to generate the data in serial ATA format and said intermediate adapter is configured to communicate in the serial ATA standard.

5. A hard disk drive adapter configured to form an intermediate adapter, comprising a serial ATA interface for communicating with a central processor, a plurality of serial ATA interfaces each for communicating with a respective serial ATA storage device, and means for mirroring, or splitting, a data input from the central processor to a plurality of channels each assigned to a respective one of the serial ATA interfaces for communicating with the serial ATA storage devices.

6. The intermediate adapter according to claim 5 configured to implement substantially automatic, substantially instantaneous RAID 1 hard disk drive mirroring, or other disk data transfer, with serial ATA.

7. In a computer system having a processor generating data output and at least one data storage device for receiving and storing the data output, the improvement which comprises:
a plurality of serial ATA data storage devices;
an intermediate adapter connected between the processor and the data storage devices for receiving the data output from the processor and for outputting the data to the data storage devices; and
means connected in said intermediate adapter for distributing the data output to a plurality of channels;
a plurality of serial ATA connections connecting each of the channels to a respective one of said serial ATA data storage device.

8. The computer system according to claim 7, wherein said serial ATA connections are serial ATA cables connecting the channels of said intermediate adapter to the data storage devices.

9. The computer system according to claim 7, wherein said intermediate adapter is entirely transparent to the computer system.
